(19) United States
(12) Patent Application Publication
(10) Pub. No.: US 2023/0343473 A1
(43) Pub. Date: Oct. 26, 2023

(54) MAGNETO-HYDRODYNAMIC DRIVE IN A CLOSED SYSTEM FOR USABLE POWER PRODUCTION FROM NUCLEOSYNTHESYS IN AN ACTIVE FLUID FLOW

(71) Applicant: Roy Alvin Bynum, Sachse, TX (US)

(72) Inventor: Roy Alvin Bynum, Sachse, TX (US)

(21) Appl. No.: 17/660,524

(22) Filed: Apr. 25, 2022

(51) Int. Cl. G21B 3/00

(52) U.S. Cl. CPC G21B 3/008

(57) ABSTRACT

A system and methods to produce usable electrical power from the energy produced by events of hot nucleosynthesis in a cold containment of flowing water driven by pulsating magneto-hydrodynamic drives used generate sustained repetition of nucleosynthesis events and collect the electrical charge potential from the ionization products caused by the ionizing radiant energy from the sustained repetitive nucleosynthesis events as a self-contained hydro-electric dynamo.

### REFERENCE TO RELATED APPLICATION

This application claims the benefit of U.S. Provisional Application Ser. No. 63/219,215 filed by Roy Alvin Bynum on Jul. 17, 2021, entitled “Magneto-Hydrodynamic Drive In A Closed System For Usable Power Production From Nucleosysthesys In An Active Fluid Flow” (sic.) commonly assigned with this application and incorporated herein by reference.

### TECHNICAL FIELD

This invention relates to the field of power generation and specifically to the safe, clean generation of power through Deuterium-Deuterium (D+D) nucleosynthesis (nuclear fusion) into helium. The process of this application is dealing with the products of hot nucleosynthesis occurring at temperatures on the order of millions of degrees within a fluid medium, flowing water, operating at nominal temperatures. Certain aspects of the system and methods of this application combine to possibly form a new technical field of study.

### BACKGROUND OF THE INVENTION

As climate change due to the release of carbon based hot house gases becomes more and more of an issue, there has been research into alternative non-solar power sources. For many years there has been attempts to build systems that produce a nuclear fusion that is not part of an explosive event or bomb. Millions of dollars have been spent on this endeavor. The problem is that, so far, as of the date of this writing, no long term useable power has been produced by these efforts. The system and processes described in this application addresses that problem.

This application is using the term “nucleosynthesis” to be more specific in the meaning of the process and methods being revealed and discussed. The more common term “fusion”, which sometimes refer to nucleosynthesis, have been extensively used to mean other things by very diverse industries and sciences to mean a very wide variety of different things. In this application the terms “fusion” and “nanofusion” refer specifically to “nucleosynthesis” specific to the synthesis of heavier atomic nuclei from lighter atomic nuclei in a similar context that it is used in astrophysics.

Hot nucleosynthesis has been around since the early days of the universe. It is the process that powers stars. Hot nucleosynthesis is the process of combining atomic light nuclei to form heavier atomic nuclei, the process that all of the elements heavier than hydrogen are formed in the stars. For the last several decades mankind has been able to duplicate this effect with varying degrees of control, but without producing safe practical energy. The first large scale man made nucleosynthesis reaction occurred during Operation Ivy in November of 1952 with the explosion of the first “Hydrogen Bomb”. Ever since then scientists and engineers have looked for ways to release energy from nucleosynthesis reactions gradually, in controlled conditions to produce practical usable power. Many have based their careers on that effort and a massive amount of money has been spent, some financed with governmental support. There have been a lot of different projects and a wide range of technologies have been developed, with for the most part, little success in producing practical electrical power that was actually usable.

It is not the intention to give a history of such efforts at this time. In this application, the term “nanofusion” refers to a single nucleosynthesis event, where a single pair of lighter nuclei are combined to form a single heavier nuclei, one at a time, as opposed to large scale nucleosynthesis or fusion events were multiple heaver nuclei are formed basically at the same time.

One notable exception to the failure to produce usable practical electrical power are the claims made by O. Gritskevitch. See the reference below under Prior Art. He filed Australian patent number AU/774445, for a device that induces nucleosynthesis in flowing water and indicates that it is able to produce usable electrical power. He claimed to have built and operated the system of his patent for several years, producing electrical power from nucleosynthesis for x-ray machines in a hospital in Armenia before the breakup of the Soviet Union. During the breakup of the Soviet Union, that system as well as all the design and operational documentation was destroyed. He also stated that because of concerns over theft of his intellectual property, there were several deliberate errors in the text and illustrations of his patent. Later, when asked, he was not able to provide specific explanation of how the electrical power is extracted from the induced nucleosynthesis. His explanation was that it operated as a “liquid Van de Graff generator”. He also referred to a form “cavitation-vacuum structures” similar to what is now referred to as acoustic resonance cavitation, or “Sono-Fusion”. In spite of the obviously misleading “errors”, his patent and what documentation is available, can be considered as prior art for this application. Because of those “errors” and his inability explain how it actually worked, the device of his system as presented, was not in reality workable.

The available documentation of Mr. Gritskevitch's system indicated that the device of his system was roughly toroid in shape with a tube on the inner circumference of the toroid going from one side of the toroid to the other, that naturally occurring resonant acoustic pulses of specific frequencies were present, that pure water was used, that the pure water was doped with heavy water, that the inner surface of the toroid was lined with a specific piezoelectric material, and that there was a ring electrode and a vertical rod electrode as part of his design. Several of the aspects of this design are to be considered as prior art for the system of this application. There are however several specific divergences from the design and operation of his described system and the system of this application.

Roy Alvin Bynum, the author of this application, was made aware of the efforts Mr. Gritskevitch as well as what documentation was available on the Internet about his system. An evaluation was made of the design of the primary device of Mr. Gritskevitch's system and the feasibility of the claims made for the ability to produce usable electrical power. In order for the system of his patent to work as claimed, several specific changes had to be made to the design of the primary device of his system. Several specific processes that were not revealed in the patent and documentation had to be in operation. Plans were made to build several different low energy devices to test the feasibility of the processes that were believed needed to be in place in order for something of the nature of what Mr. Gritskevitch claimed to have done. As such, the work and reviled information of Mr. Gritskevitch is to be considered as prior art. As such, while there are similarities, there several distinctive differences between the system and methods of this application and the system as revealed by Mr. Gritskevitch.

One of the most difficult issues to address in the development of the system of this application was the concept of the ability of flowing pure water to retain the electrically charged ions and cations produced by ionizing radiation. Under laboratory conditions, the products of ionizing radiation in water quickly recombine, meaning that water does not normally have the ability to retain the electrically charged ions and cations produced by ionizing radiation. In experimentation with very low energy devices built by Roy Bynum, he was able to demonstrate that it was possible for an ionic solution of flowing water to retain the products of ionizing radiation and then be detectable as an electrical charge on electrodes down stream of an ionizing radiation source. This research was published under the name “Passive Nuclear Energy”. See the “PNE Research” reference below.

It was postulated that those “naturally occurring” acoustic pulses were used to produce cavitation bubbles in the flowing water, which would then implode and produce individual nucleosynthesis events in the flowing water. This functional process is similar to the concept known as “bubble fusion”, also referred to as “Sono-Fusion”. The mathematical models for this process are similar to what is known as “sonoluminescence”. See the references below to the articles on these topics.

In 2002 the term “Sono-Fusion” was coined as the technical term for what was known as “bubble fusion”. The concept of Sono-Fusion was initially discredited, but later verified several times through repeated experimentation. Sono-Fusion is a function of acoustic resonance of a mixture of deuterated chemicals which produced cavitation bubbles that then imploded, causing multiple events of fusion, which was detected by radiation detectors. Repeated experimentation also found that this was not easily repeated. The validity of the work was repeatedly brought into question. There are several patents that utilize Sono-Fusion in an attempt to produce usable power. Many refer to the use of heavily enriched fluids and EMF excitation to generate the desired reactions. Other approaches may use magnetic fields to isolate ions similar to the published experiments by PNE Research on You-Tube. This can be considered as prior art. While the system described in this application utilizes the nature of Sono-Fusion to produce radiant energy, this application provides a mechanism for maintaining continuing, repeated single events of fusion (“nanofusion” events) in pure water and a method of collecting the energy from those nanofusion events as usable electrical power without the requirement for magnetic fields to isolate the ions.

Another postulated process that had to be in place, but was not documented or explained, had to do with the piezoelectric material that lined the inner surface of the primary device of Mr. Gritskevitch's system. Mr. Gritskevitch recognized that the resonant acoustic pulses caused transient electrical charges on the inner surface of the piezoelectric material, but to him, the only effect it had in his system was to produce electro static discharges which helped to produce a form of cold fusion. This process utilized the transient electrical charges produced on the surface interface between the piezoelectric material and flowing water.

It was postulated that the transient electrical charges on the piezoelectric material actually generated bubbles of kinetically charged ions (plasma) and cations that were dispersed in the flowing water. The bubbles of kinetically charged plasma, and cations themselves carried a static electric charge which then provided the ionic material to turn the pure water into an ionic solution. This was proven by additional experimentation by Roy Bynum. In this application this method of producing statically charged bubbles of kinetically charged ions/plasma and cations is referred to as “Piezo Pumped Plasma”.

In pure water, the bubbles of kinetically charged plasma would contain a certain percentage of naturally occurring deuterium ions, which would also become “fuel” for the before mentioned nanofusion events. This process can be enhanced by adding a small amount of heavy water which has deuterium in place of hydrogen to make up the heavy water molecule. With this application the mathematical models for the mechanism of sonoluminescence are altered by the pressure waves operating on the bubbles in the flowing water occur at acoustic resonance, which is at the speed of sound within the water. Also the ambient pressure is much higher in the system of this application as well. This application includes a utilization of this method to also produce statically charged bubbles as ionic material so as to produce an ionic solution of pure water and components of pure water to enable the retention of separated ions and cations as a result of ionizing radiation from nanofusion events.

Several test systems have been built but the method claimed by Mr. Gritskevitch to jump start his system and then drive movement of the water in his system was never able to be duplicated. Another method of causing the movement of the water had to be invented and incorporated in this application. This application utilizes that same functionality of a magneto-hydrodynamic drive to cause the movement of water in a closed system. This application however applies that functionality with the use of very pure water. The specific implementation and operation of that drive is also used as part of the functionality to provide and maintain an initial ionization of water in a closed system, so that useful electrical power can be provided by that system.

Electric direct current that is used for a magneto-hydrodynamic drive is also used for electrolysis in water. In this process hydrogen gas and oxygen gas if formed at the positive and negative electrodes of the drive. This does not produce any usable ions to provide and maintain initial ionization of the water in the drive. A side effect of the use of direct current in ionic water is the striping of metallic ions from electrodes, which in turn produces corrosion in those electrodes, and then contaminates the water. This process is deliberately utilized by industry in the process of electro-plating. Because of the contamination, standard current based magneto hydrodynamic drive is not considered as fully appropriate for the system of application, but has been included in this application.

An additional, a novel design of a magneto hydrodynamic drive has been incorporated in the system of this application. This novel magneto hydrodynamic drive method that utilizes the dipole nature of pure water molecules to stimulate a movement of electrons through the use of high voltage electrostatic fields. The nature of this method of stimulating the movement of electrons also induces pulses into the movement of the pure water. This novel magneto hydrodynamic drive is referred to as “Electrostatic Induction Magneto Hydrodynamic Drive” (“electrostatic induction drive”). In this regard, the system of this application is very different from the system purported by Mr. Gritskevitch. The system of this application is also specifically designed to be scalable.

The pulses induced in the pure water by the electrostatic Induction Drive can be regulated at specific frequencies to produce resonant acoustic waves in the flowing water to act as the acoustic pulses to stimulate the production static charged bubbles of kinetically charged ions/plasma and cations of the Piezo Pumped Plasma method of this application. That method of induced resonant acoustics driving the Piezo Pumped Plasma method also provides and maintains that initial ionization required to prevent ionization products from ionizing radiation from quickly recombining. The resonant acoustics from the electrostatic induction drive also provides the acoustics needed for the generation of nanofusion events through the process of bubble fusion or Sono-Fusion mentioned earlier.

### PRIOR ART

AU/774445 by O. Gritskevitch

O. Gritskevitch: www.rexresearch.com/gritskevich/gritskevich.htm

PNE Research: www.youtube.com/channel/UCFgdJG_4ZqPGm6Zs2Jufb5A

### CROSS REFERENCES

### Mechanism of Sonoluminescence

Michael P. Brenner (2002). “Single-bubble sonoluminescence”. Reviews of Modern Physics. 74 (2): 425-484. Bibcode:2002RvMP . . . 74 . . . 425B. CiteSeerX 10.1.1.6.9407. doi:10.1103/RevModPhys.74.425.
Thomas J. Matula; Lawrence A. Crum (1998). “Evidence for Gas Exchange in Single-Bubble Sonoluminescence”. Physical Review Letters. 80 (4): 865-868. Bibcode:1998PhRvL . . . 80 . . . 865M. doi:10.1103/PhysRevLett.80.865. S2CID 115140924.
K. S. Suslick; W. B. McNamara Ill; Y. Didenko (1999). “Hot Spot Conditions During Multi-Bubble Cavitation” (PDF). Sonochemistry and Sonoluminescence: 191-205. doi:10.1007/978-94-015-9215-4_16. ISBN 978-90-481-5162-2.
Joe Zeljko Sostaric (1999). Interfacial Effects on Aqueous Sonochemistry and Sonoluminescence. pp. 1-252.
Gaitan, D. Felipe; Lawrence A. Crum; Charles C. Church; Ronald A. Roy (June 1992). “Sonoluminescence and bubble dynamics for a single, stable, cavitation bubble”. Journal of the Acoustical Society of America. 91 (6): 3166-3183. Bibcode:1992ASAJ . . . 91.3166G. doi:10.1121/1.402855. Archived from the original on 14 Apr. 2013. Retrieved 29 May 2011.
Keller, Joseph B.; Michael Miksis (August 1980). “Bubble oscillations of large amplitude”. Journal of the Acoustical Society of America. 68 (2): 628-633. Bibcode:1980ASAJ . . . 68 . . . 628K. doi:10.1121/1.384720. Archived from the original on 14 Apr. 2013. Retrieved 30 May 2011.
Prosperetti, Andrea; Lawrence A. Crum; Kerry W. Commander (February 1988). “Nonlinear bubble dynamics”. Journal of the Acoustical Society of America. 83 (2): 502-514. Bibcode:1988ASAJ . . . 83 . . . 502P. doi:10.1121/1.396145. Archived from the original on 14 Apr. 2013. Retrieved 30 May 2011.
Flynn, H. G. (June 1975). “Cavitation dynamics. I. A mathematical formulation”. Journal of the Acoustical Society of America. 57 (6): 1379-1396. Bibcode:1975ASAJ . . . 57.1379F. doi:10.1121/1.380624. Archived from the original on 14 Apr. 2013. Retrieved 30 May 2011.
Flannigan D J, Suslick K S. 2008. Inside a Collapsing Bubble: Sonoluminescence and the Conditions During Cavitation. Annu. Rev. Phys. Chem. 59:659-83
Flannigan, D. J.; Suslick, K. S. “Plasma Formation and Temperature Measurement during Single-Bubble Cavitation” Nature, 2005, 434, 52-55.
Barber, Bradley P.; Robert A. Hiller; Ritva Losfstedt; Seth K. Putterman; Keith R. Weninger (1997). “Defining the Unknowns of Sonoluminescence”. Physics Reports. 281 (2): 65-143. Bibcode:1997 PhR . . . 281 . . . 656. doi:10.1016/50370-1573(96)00050-6.
Flint, E. B.; Suslick, K. S. (1991). “The Temperature of Cavitation”. Science. 253 (5026): 1397-1399. Bibcode:1991Sci . . . 253.1397F. doi:10.1126/science.253.5026.1397. PMID 17793480. S2CID 22549622.
McNamara III, W. B.; Didenko, Y.; Suslick, K. S. (1999). “Sonoluminescence Temperatures During Multibubble Cavitation”. Nature. 401 (6755): 772-775. Bibcode:1999Natur.401 . . . 772M. doi:10.1038/44536. S2CID 4395942.
Didenko, Y.; McNamara III, W. B.; Suslick, K. S. (2000). “Molecular Emission from Single Bubble Sonoluminescence”. Nature. 406 (6798): 877-879. Bibcode:2000Natur.406 . . . 877M. doi:10.1038/35038020. PMID 11057659. S2CID 4335459.
Didenko, Y.; Suslick, K. S. (2002). “The Energy Efficiency of Formation of Photons, Radicals, and Ions During Single Bubble Cavitation”. Nature. 418 (6896): 394-397. Bibcode:2002Natur.418 . . . 394D. doi:10.1038/nature00895. PMID 12140551. S2CID 658166.

### Mechanism of Bubble Fusion

Michael P. Brenner (2002). “Single-bubble sonoluminescence”. Reviews of Modern Physics. 74 (2): 425-484. Bibcode:2002RvMP . . . 74 . . . 4256. CiteSeerX_10.1.1.6.9407, doi:10.1103/RevModPhys.74.425,
Thomas J. Matula; Lawrence A. Crum (1998). “Evidence for Gas Exchange in Single-Bubble Sonoluminescence”. Physical Review Letters. 80 (4): 865-868. Bibcode:1998PhRvL . . . 80 . . . 865Mdoi:10.1103/PhysRevLett.80.865S2CID_115140924,
K. S. Suslick; W. B. McNamara Ill; Y. Didenko (1999). “Hot Spot Conditions During Multi-Bubble Cavitation” (PDF). Sonochemistry and Sonoluminescence: 191-205. doi:10.1007/978-94-015-9215-4_161SBN_978-90-481-5162-2,
Joe Zeljko Sostaric (1999). Interfacial Effects on Aqueous Sonochemistry and Sonoluminescence. pp. 1-252.
Gaitan, D. Felipe; Lawrence A. Crum; Charles C. Church; Ronald A. Roy (June 1992). “Sonoluminescence and bubble dynamics for a single, stable, cavitation bubble”. Journal of the Acoustical Society of America. 91 (6): 3166-3183. Bibcode:1992ASAJ . . . 91.3166G, doi:10.1121/1.402855. Archived from the original on 14 Apr. 2013. Retrieved 29 May 2011.
Keller, Joseph B.; Michael Miksis (August 1980). “Bubble oscillations of large amplitude”. Journal of the Acoustical Society of America. 68 (2): 628-633. Bibcode:1980ASAJ . . . 68 . . . 628Kdoi:10.1121/1.384720. Archived from the original on 14 Apr. 2013. Retrieved 30 May 2011.
Prosperetti, Andrea; Lawrence A. Crum; Kerry W. Commander (February 1988). “Nonlinear bubble dynamics”. Journal of the Acoustical Society of America. 83 (2): 502-514. Bibcode:1988ASAJ . . . 83 . . . 502Pdoi:10.1121/1.396145. Archived from the original on 14 Apr. 2013. Retrieved 30 May 2011.
Flynn, H. G. (June 1975). “Cavitation dynamics. I. A mathematical formulation”. Journal of the Acoustical Society of America. 57 (6): 1379-1396. Bibcode:1975ASAJ . . . 57.1379F, doi:10.1121/1.380624. Archived from the original on 14 Apr. 2013. Retrieved 30 May 2011.
Flannigan D J, Suslick K S. 2008. Inside a Collapsing Bubble: Sonoluminescence and the Conditions During Cavitation. Annu. Rev. Phys. Chem. 59:659-83
Flannigan, D. J.; Suslick, K. S. “Plasma Formation and Temperature Measurement during Single-Bubble Cavitation” Nature, 2005, 434, 52-55.
Barber, Bradley P.; Robert A. Hiller; Ritva Losfstedt; Seth K. Putterman; Keith R. Weninger (1997). “Defining the Unknowns of Sonoluminescence”. Physics Reports. 281 (2): 65-143. Bibcode:1997 PhR . . . 281 . . . 65Bdoi:10.1016/S0370-1573(96)00050-6,
Flint, E. B.; Suslick, K. S. (1991). “The Temperature of Cavitation”. Science. 253 (5026): 1397-1399. Bibcode:1991Sci . . . 253.1397F. doi:10.1126/science.253.5026.1397, PMID_17793480S2CID_22549622,
McNamara Ill, W. B.; Didenko, Y.; Suslick, K. S. (1999). “Sonoluminescence Temperatures During Multibubble Cavitation”. Nature. 401 (6755): 772-775. Bibcode:1999Natur.401 . . . 772Mdoi:10.1038/4453652CID_4395942,
Didenko, Y.; McNamara Ill, W. B.; Suslick, K. S. (2000). “Molecular Emission from Single Bubble Sonoluminescence”. Nature. 406 (6798): 877-879. Bibcode:2000Natur.406 . . . 877Mdoi:10.1038/35038020PMID_11057659S2CID_4335459,
Didenko, Y.; Suslick, K. S. (2002). “The Energy Efficiency of Formation of Photons, Radicals, and Ions During Single Bubble Cavitation”. Nature. 418 (6896): 394-397. Bibcode:2002Natur.418 . . . 394Ddoi:10.1038/nature00895PMID_12140551S2CID_658166,

### DESCRIPTION OF THE SYSTEM OF THE INVENTION

The system described in this application is based on a hollow ring torus. In this application, the terms “hollow torus” and “torus” is referring to the hollow ring torus. The hollow torus is made of a hard, non-magnetic, non-conductive, and radiation resistant material that is also resistant to corrosion and moderately high temperatures. The hollow torus is illustrated primarily in FIG. 1 and as parts in FIGS. 2, 3, 8, 16, 17, 18, and 19. FIG. 1 has top view of the hollow torus (100). The inner surface of the torus is lined with piezoelectric material (120). The piezoelectric material can be either traditional ceramic based or newer piezo-polymer material. High purity water fills the volume of the torus (145). The inner surface of the piezo-electric material is very smooth so as to not cause turbulence or other disruption to the flow of water around the inside of the hollow torus. The center point of the hollow section around the hollow torus forms a circular axis (130) around the center of the hollow of the hollow torus.

The hollow torus is inside of at high pressure containment vessel that is also made of nonmagnetic, corrosion resistant and radiation resistant material (200). A structure is in place inside the containment vessel to assure that the water continues to fill the volume of the torus so that no gas or air is allowed to accumulate in the hollow of the torus (160).

Another water maintenance structure (165) is outside the containment vessel that assures the overall water level of the water in the hollow torus and the containment vessel and to maintain the operational pressure within the containment vessel. The outside water maintenance structure also acts to draw off any water the hollow torus that may contain any non-reactive gases and separate the non-reactive gases from the water. A pressure relief safety valve (280) is also in place on the containment vessel.

### Current Based Magneto Hydrodynamic Drive Elements

In one implementation form of the system there are a set of two metal electrically conductive electrodes (FIG. 3, 300) located on the inner surface of the torus at a position that will set them in between a set of two saddle coils (330). The material, size and shape of these electrodes will be specific to the implementation of the system. The electrodes are to provide an electrical direct current from one side of the toroid section to the other across the diameter of the toroid section such that when a magnetic field is formed between the set of two saddle coils, which the current between the electrodes the flows through. This then induces movement of the water which is the standard functional architecture of a magneto-hydrodynamic drive. The saddle coil sets are closely arranged in pairs of sets (FIG. 1, 300). The saddle coils are connected to a Resonance Control Computer for Traditional Current Based Drive (FIG. 4, 340). This computer controls timing of pulsating electrical current to the saddle coils at specific frequencies that produce acoustic resonances with the hollow torus. One set of saddle coils is pulsed at a frequency that produces a half wave resonance while the second of saddle coils is pulsed at a frequency that produces a quarter wave resonance (FIG. 4). The Resonance Control Computer, waveform generators, amplifiers, and switches are located outside of the containment vessel as a sub-system (910) of an overall master control system (FIG. 1, 180 and FIG. 20, 180, 910) and connected to the electrodes and coils by cabling through high pressure bulkhead seals or high pressure bulkhead connectors.

### Electrostatic Based Magneto Hydrodynamic Drive Elements

In one implementation form of the system there are pairs of electrostatic induction drive elements. The number and locations of these drive elements will be specific to different implementations of the system. Each pair is made up of two individual electro-static induction drive units. Each electro-static induction unit made up of two saddle coils (FIG. 1, 500, FIG. 8, 500) on opposite sides of the outside of the hollow torus and two high voltage electrodes (FIG. 1, 510, FIG. 8, 510) on the outside of the hollow torus on top and bottom of the hollow torus. The high voltage electrodes are curved metal electrically conductive plates and insulated to inhibit arching between the plates. The size and shape of these plates will be specific to the implementation of the system. These plates are to have pulses of very high voltage from one plate to the other such that the electrical charge field between the plates causes the dipole of the water molecules to orient in line with the electrical charge field between the plates.

The voltage on the plates is made to alternate positive to negative (FIG. 8, FIG. 9). The alternating charge field across the water column between the charge plates causes the natural cohesion between the water molecules to break and to realign relative to the polarity of the electrical charge field (FIG. 8). Each set of electrodes (510) are located between a set of saddle coils (500) such that an electro-static field generated by the plates when high voltage is applied (FIG. 9, FIG. 10), will be within the alternating magnetic field between the saddle coils, normal to that magnetic field (FIG. 9, FIG. 10)). The current to the saddle coils is approximately 90° out of phase with the voltage to the electrodes (FIG. 10). The current to the saddle coils is applied first (FIG. 10, 555), then after the magnetic field between the saddle coils is at full saturation, the voltage to the electrodes (FIG. 10, 550) is applied. This produces short duration induced drive impulse in water at the leading edge of the voltage increase across the electrodes (FIG. 10, 570). The alternating current in the saddle coils in conjunction with the alternating voltage in the electro-static charge elements (FIG. 10, 450, 455), causes the water molecules to rotate back and forth (FIG. 10, 460), generating a drive impulse with each half cycle of current and voltage (570). Depending on the frequency of the alternating cycles, the water molecules may be allowed to return to a cohesive state between each half of the alternating cycle (FIG. 10, 440)

Each drive unit set of saddle coils and conductive plates come in a pair of such drive unit sets. A Resonance Control Computer for Electro-static Induction Drive System (FIG. 9 520) is in place for each pair of saddle coil and conductive plate sets. This computer controls timing (5250 of the electrical current to the saddle coils and electrical voltage to the conductive plates. For each pair of sets of saddle coils and conductive plates there is an A set and a B set. The computer sends timing signals to two waveform generators (530) for each drive set. The timing and shape of the waveform signals are different based on half wave (534) or quarter wave (536) acoustic resonance pulse set. The waveform is also different between the signal to the high voltage amplifier/switches (550) and the signal to the high amperage amplifier switches (545). The high voltage amplifier switches send timed high voltage signals (550) to the high voltage electrostatic field electrodes (510). The high amperage amplifier switches provide the high current signals (555) to the high gauss drive coils (500) of each drive set.

The voltage to the electrodes and the current to the saddle coils are pulsed at frequencies that produce acoustic resonance in the cavity of the hollow torus. One drive unit set is pulsed at a half wavelength acoustic resonance and the other drive unit set of each pair is pulsed at quarter wavelength acoustic resonance. The Resonance Control Computer, waveform generators, amplifiers, and switches are located outside of the containment vessel as a sub-system (920) of an overall master control system (FIG. 1, 180 and FIG. 20, 180, 910) and connected to the electrodes and coils by cabling through high pressure bulkhead seals or high pressure bulkhead connectors.

### Power Extraction Elements

The torus also contains one or more set(s) of electrodes made up of two elements (FIG. 18). One element of each set is in the form of a ring (800) that has a diameter that is about 80% of the inside diameter of the inner surface of the torus, positioned equidistance from the inner surface of the torus. The other element of each electrode set is a short rod like form (850) located in line with the section axis at the center of the hollow of the torus. The rod like form is slightly curved to match the radius of section axis with the rotation of the torus. Both the ring and rod like electrodes are positioned close to each other but not touching (Section E-E, Cutaway F-F). The rod may be positioned in the center of the ring along the segment axis of the hollow torus (Cutaway F-F) or slightly behind the ring relative to the direction of the water flow. Both the ring and rod electrodes are held in place by mounts (880,885) that are held in place and goes through the surface of the torus to provide electrical connections to each electrode (810,860). The electrical connections are to provide the electrical power output from the system. The mounts for the ring and rod electrodes are covered in insulating material to prevent any contact with the ions in the water. The number and locations of the sets of electrodes will be specific to the implementation of the system. High current cabling connects the terminals of the power output electrode to output power management sub-system (FIG. 20, 990) of the master control system (180). The high current cabling along with other control and sensor cabling (185) runs from inside the containment vessel to the power management system outside the containment vessel through high pressure bulkhead seals, or high pressure, high current connectors. From the power management sub-system, the output power (190) is routed to destination power clients. These electrodes are also the only objects in the direct path of the flowing water acting as an impediment to the movement of the water, particularly at any velocity. Because of these electrodes, without a constant driving force, the water would quickly slow down, greatly reducing the electrical potential between the power output elements of the system of this application.

### Master Control System

There is a master control system that is made up of various monitoring and control sub-systems (FIG. 1, 180 and FIG. 20). All of the sub-systems respond to and/are controlled by a master control system computer (900). The primary sub-systems that are controlled by the master control system are the current based resonance drive (910) and the electrostatic based resonance drive (920). The feedback for the two forms of drives is from the acoustic sensor monitoring system (930), which with the Doppler detection acoustic sensor (935) detects the pulses from the drive units as they propagate through the water inside the hollow torus and any frequency shifts that occur because of the Doppler affect caused by the speed of the water flowing past the sensor. This is correlated with the water flow monitoring and control system (940) which detects the speed of the water flow and helps to maintain it at an optimum speed for the desired power output. The temperature monitoring system (950) provides information about the heat being produced inside the hollow torus as controlling the overall cooling system (955). The cooling system also provides information to the master control computer of the operational effectiveness of the overall cooling system and can be overridden directly by the master control computer. The light water and non-reactive gas removal system 960) acts to process the water that has un-recombinant ion and cation gases in solution in the pure water gathering in the hollow torus and containment vessel. It also acts to remove the inert, non-reactive gas that is the product of the nanofusion events in the system of this application. Working in conjunction light water and non-reactive gas removal system are the pure water injection and water level maintenance system (970) and the containment vessel pressure monitoring and control system (980). The master control system also contains the power output monitoring sub-system (990) which monitors the power output of the system of this application to maintain both minimum output for a given load and maximum output for the continuous operating circumstances such as water flow rate, heat output, cooling system effectiveness and other safety factors. It will also provide short circuit and power shunt protection should the need arise.

### DESCRIPTION OF THE FUNCTIONALITY OF THE INVENTION

### Traditional Current Based Magneto Hydro-Dynamic Drive

In the traditional current based drive takes advantage of the electrostatic imbalance of water molecules in presence of a magnetic field. What is called “Fleming's right hand rule” shows the direction of thrust when current is induced in a conductor in the presence of a magnetic field. In this case, the “conductor” is water. Direct current is induced between electrodes (FIG. 3, 300) on opposite sides of a section of the hollow torus. Saddle coils (330) are used to produce the magnetic field that is used to produce thrust in the water. This thrust causes the water in the closed system of the hollow torus to accelerate in a specific direction around the inside of the hollow torus. The speed of the water flow in this closed system can be controlled by the strength of the magnetic field and the amount of current flowing between the electrodes, or a combination there of.

In the system of this application, the electrical current to the saddle coils pulsed at an acoustic frequency that is a harmonic of the speed of sound of the water in the torus at the distance of the diameter of the torus through the toroid section. The harmonic frequency can be at a subset of the exact harmonic or “full wave” of the toroid section. The harmonic frequency can also be at one half (“half wave) or one quarter (quarter wave) of the exact harmonic of the toroid section. When multiple sets of the saddle coils are employed as in the case of the system of this application, a mix of half wave and quarter wave resonant acoustic pulses are produced. In addition to causing he water to move within the closed system of the hollow torus, the resonant acoustic pulses has other functions which will be explained further in this application.

The speed of the flowing water in the hollow torus can be governed by the combination of the amount of current between the electrodes and the strength of the magnetic field between the electrodes. Should the speed of the flowing water need to be slowed down, the magnetic field can be reversed for the time needed to bring the flowing water to the desired speed. In this way the flow of the water can even be stopped if needed.

### Electrostatic Induction Magneto Hydro-Dynamic Drive

This takes advantage of the dipole nature of pure water. A water molecule (FIG. 5, 400) is made up of one (1) oxygen atom (410) and two (2) hydrogen atoms (420). The hydrogen atoms tend to group at one end of the water molecule as illustrated in FIG. 5. Because of the valence difference between the oxygen atom and the hydrogen atoms, the oxygen atom tends to capture the electrons from the hydrogen atoms, leaving the molecule with an effective electrostatic field at each end, a positive field (430) at the hydrogen end of the molecule and a negative field (435) at the oxygen end of the molecule.

When pure water, including pure heavy water, is at rest (FIG. 6), the molecules arrange in what is known as a cohesive state (440). Due to the electrostatic fields at each end of a water molecule tend to adhere the hydrogen atoms to the oxygen atom of an adjacent water molecule, creating what is known as a cohesive bond (445). This bond is not as strong as the valence bond between the hydrogen and oxygen atoms of an individual water molecule. The cohesive bond is strong enough to produce an internal linkage pressure which becomes the basis of what is known as “water tension” and is seen by the effect of the capillary action of water overcoming gravity by a small amount in small dimension glass tubes. This cohesive bond effect also applies to heavy water molecules in the water. It is this cohesive bondage that provides the surface tension of the bubbles that are formed as part of the piezo pumped plasma process described later in this application.

Very high voltage electrical fields can disrupt the natural cohesion, forcing the individual water molecules to align relative the electrical fields (FIG. 7 450, 455). If the high voltage field is relaxed the water will return to its natural cohesion state (FIG. 6). When the high voltage field is initially applied the re-orientation of the individual molecules causes an apparent electrical charge movement within the column of water (460) between the poles of the high voltage field. If the high voltage field is applied fast enough, this causes the re-orientation of the individual molecules inducing an apparent movement electrons/protons at a molecular level (460). It is the same effect as if a very short pulse of electrical current is externally induced in the pure water.

When this induced movement of electrons/protons is forced in the presence of a strong magnetic field (FIG. 10), a very small impulse of movement is applied to the column of water between the poles of the electrical field (570). By itself, a single impulse of movement of size does not apply much force or acceleration to the water column. By inducing a large number of these impulses at high frequency, enough energy can be applied to the water column to cause if to accelerate to motion similar to the manor normally utilized in a magneto-hydrodynamic drive system (575). There is a specific timing relationship between the current producing the magnetic field in the drive saddle coils and the leading edge of the voltage to electrostatic as shown in FIG. 10. The high current signal (555) to the drive coils is sent before the high voltage (550) signal to the high voltage field electrodes. The timing difference allows the magnetic field (560, 565) of the coils to be at full strength before the leading edge of signal to the high voltage field electrodes. This is about a 90° phase difference between the signals. A relaxation period occurs which allows the current and voltage signals to zero out. The next set of signals to the drive coils and high voltage electrodes is of the opposite polarity. This produces a negative to positive electrostatic field within a north to south magnetic polarity and then a reversal of a positive to negative electrostatic field within a south to north magnetic field. This reversal of electrostatic fields (450, 455) tends to cause greater atomic movement of the hydrogen and oxygen atoms within the water molecules (460), effectively a complete reversal, almost causing the water molecules to “spin”. This produces a virtual alternating current between high voltage electrostatic electrodes. When this virtual alternating current occurs within a coordinated alternating magnetic field, short bursts of thrust is induced in the water, in the same manner of the current based magneto hydrodynamic drive, without the issues that go with the current based drive.

In the system of this application, the magnetic fields of the saddle coils and the voltage of electrostatic elements of each drive set within a drive pair are pulsed at acoustic frequencies that are resonant harmonics of the speed of sound of the water in the torus at the distance of the diameter of the torus through the toroid section. One set is pulsed at the resonant harmonic frequency of one half (“half wave) and the other set is at the resonant harmonic frequency of one quarter (quarter wave) of the exact harmonic of the toroid section. A pair of drive sets are operating as in the case of the system of this application, a mix of half wave and quarter wave resonant acoustic pulses are produced. In addition to causing the water to move within the closed system of the hollow torus, the resonant acoustic pulses has other functions which will be explained further in this application.

The speed of the flowing water in the hollow torus can be governed by the combination of the strength of the high voltage to the high voltage electrodes and the strength of the magnetic field between the electrodes. Should the speed of the flowing water need to be slowed down, the magnetic field can be reversed for the time needed to bring the flowing water to the desired speed. In this way the flow of the water can even be stopped if needed.

### Piezo Pumped Plasma

The primary initial source of ionization of the pure water in the hollow torus is the effect that the acoustic resonance waves have on the piezoelectric material lining the inside of the hollow torus. When the system of this application is not operating (FIG. 11), the charges on the surface are somewhat neutral (608). The water molecules are in the normal cohesive state (604). An occasional heavy water molecule (605) is naturally occurring in all water on the earth.

The resonant acoustic pulses generated by the hydrodynamic drive units propagate through the water in the hollow torus creating acoustic pressure waves (FIGS. 12 through 15, 610). Because the water is moving around the hollow of the torus, the acoustic pressure waves become collimated in the direction of water flow. As an acoustic pressure wave moves across the surface of the piezoelectric material, it induces a transient electrical charge component on the surface of the piezoelectric material (FIGS. 12 through 15, 614). In the illustrations of this application, the initial transient charge component is negative (FIG. 12), which tends to attract the hydrogen atoms of the water molecules, causing them to align on the surface of the piezoelectric material (620). Water that is touching this surface where it has a negative charge tends to pick up some of that electrical charge and then split into the ions of Hydrogen (2H⁺) and Oxygen/Hydroxyl (2O⁻/OH⁻) (620). Ionic atoms that gain electrons are known as cations. At locations where the electrical charge is positive, electrons are striped from the water molecules, producing additional ionization (626). As the acoustic pressure wave moves on, the pressure on the surface of the piezoelectric material is reversed, causing a reversal of the transient electrical charge (616). The initial reversal of charge from negative to positive tends to then attract the oxygen atoms that have picked up the electrons from the hydrogen atoms to become cations (626). The hydrogen atoms that have lost electrons become positively charged plasma (624) and are repulsed by the positive charge on the surface of the piezoelectric material. The pressure from separating the cation and plasma atoms starts form a laminar bubble (628) on the surface of the piezoelectric material.

As the acoustic pressure wave moves on the electrical charge component of the piezoelectric material again reverses (FIG. 13, 614)). The lighter plasma hydrogen ions is attracted to the negative charged areas of the piezoelectric material (630) while the oxygen/hydroxyl cations are repulsed from the negative charged area (634). Because the hydrogen ions are lighter than the oxygen/hydroxyl cations, the lighter plasma hydrogen ions react faster to the changes on the surface of the piezoelectric material and are separated from the heaver oxygen/hydroxyl ions. As the separation of the ions and cations occurs, a laminar bubble (636) becomes fully formed on the surface of the piezoelectric material. The next reversal of the pressure wave causes another reversal of the transient charge (614), this time to positive. The positive charge attracts the negatively charged oxygen/hydroxyl cations and repulses the positive charged plasma hydrogen ions. The heaver cations (644) move toward the surface of the piezoelectric material while the lighter hydrogen ions begin to pick up kinetic energy (640) move even further from the surface of piezoelectric material, expanding the size of the laminar bubble (646).

FIG. 14 shows two more reversals of the transient charges on the surface of the piezoelectric material. The ions (650, 660) and cations (654, 664) are repeatedly pushed and pulled by the electrical charge changes. Through additional reversals of the transient electrical charges, more and more kinetic energy (658, 668) is pumped into the ions and cations. As the kinetic energy builds in the ions and cations, the laminar bubble continues to expand (656, 666).

As this process continues (FIG. 15), the ions and cations build kinetic energy, and separation of the ions and expands. The ions (670) and cations (674) become less attracted to the surface of the piezoelectric material and the laminar bubble separates from the surface of the piezoelectric material (676). When the laminar bubble separates from the piezoelectric material it fragments. The fragmentation of the laminar bubble causes individual bubbles of positively charged hydrogen ions to form (682), while the oxygen/hydroxyl cations form negatively charged bubbles (680). If the kinetic energy of the ions and cations is great enough, the formed bubbles will resist breaking up into individual ions and cations, and become “dissolved” in the pure water as ionic “material” in solution in the pure water (686).

When electrons are stripped off of the atoms an element in a gaseous state, those atoms become what is known as a plasma of that element. Most often plasmas are generated by very high heat, as in the form of plasma cutting torches and most Sono-Fusion based patents. In the case of this application, the hydrogen atoms that are ionized become a cold form of plasma. As more ionization occurs these hydrogen form bubbles of hydrogen plasma (682) containerized by the surface tension of the pure, non-ionized water around each bubble (686). The positive charged ion bubbles and the negative charged cation bubbles are basis of seed ionization in the pure water, which reduces the overall recombination of ion recombination when the pure water is ionized by the nanofusion events.

A percentage of these hydrogen plasma bubbles also contain Deuterium plasma (688). It is these Deuterium plasma bubbles that become the fuel for the acoustically driven nanofusion events which are the source of the power generated by the system of this application. By having low temperature Deuterium plasma, the amount of acoustic pressure needed to generate the nanofusion events is greatly reduced compared to existing known forms of Sono-Fusion. Existing Sono-Fusion methods require that the acoustic or other resonance generating methods generate enough pressure to first form a non-plasma bubble, then initiate a collapse of that bubble which then heats the elements in the bubble to strip the electrons from the elements, momentarily producing a plasma before fully collapsing the bubble to initiate the actual Sono-Fusion event. The piezoelectric pumped plasma method greatly increases the probability of a nanofusion event for a given availability of fissionable Deuterium.

The statistical formation rate of Ion and cation bubbles is based on the acoustic resonance frequencies and the strength of the transient charges on the piezoelectric material surface. The greater the strength of those charges, the greater the number of bubbles that will be formed. The Deuterium plasma bubbles can be calculated based on the volume of pure water in the hollow torus, and the percentage of heavy water in that volume as a percentage of the overall bubble formation.

The patterns or zones of alternating pressure produced by the hydrodynamic drive units is represented in FIG. 16. A pattern (700) is shown for both the half wave (710) and the quarter wave (720) resonance frequencies. The half wave resonance produces pressure zones on the inner surface of the hollow torus and one at the section axis point (715) of the hollow torus. The quarter wave resonance produces resonance also produces pressure zones on the inner surface of the hollow torus, with three additional pressure zones equidistance (725) across the section of the hollow torus. The patterns shown in FIG. 6 do not show that the pressure waves are in reality circular in nature and move across the inside surface of the piezoelectric material in the form of circular waves. Additionally, the half wave and quarter wave resonance generate a multiplied pressure zone (730) at the section axis of the hollow torus for the entire circumference of the hollow torus. This this zone of multiplied acoustic pressure that becomes the zone within the hollow torus where the nanofusion events are most likely to occur.

Water flowing through a smooth bend in piping takes on a Coriolis form of movement because the water on the inside of the bend has less distance to move, while the water on the outside of the bend has a longer distance to move. In the case of the hollow torus, because of that Coriolis affect the water takes on a helical path around the interior of the hollow torus. This becomes a circular movement within the overall toroid sections of the torus (FIG. 17, 760). Between the linier movement of the water around the inside of the torus and circular movement around the toroid section, the ionization generated by the piezoelectric material get dispersed into “zones” through the moving water. Because of the additional circular movement of the water centrifugal forces tend to cause the heaver hydroxyl and oxygen cations and negative charged cation bubbles to gather toward the outer circumference of the toroid section (750). This also tends to cause the lighter positive hydrogen ions and positive charged plasma bubbles to collect toward the center of the torus section (740). This effectively segregates the negative cations and positive ions, further preventing their recombination. Pure water is a good electrical insulator. The volume of pure water between the outer cation zone and the inner plasma/ion zone (145) acts to electrically insulate the negative charges from the positive charges in the separated zones.

This circular movement of the ions into semi-isolated zones causes the ionization of the water to be maintained at a relatively high level. The space between the zones of ionization acts to provide a level of electrical insulation from the voltage potential between the zones of ionization. The dispersed ions then also act as an initial ionization in the water to support the capture of ions produced by any ionizing radiation. Within the torus the initial ionization is maintained as long as the water is moving at a minimal rate. Depending on the level of ionization generated by the ionizing radiation, the large number of ions generated by the radiation along with the small number of the initial ions are available to provide useable electrical power

In addition to producing initial ionization of the water, the harmonic acoustics produce a zone of acoustical cavitation and implosion along the entire section axis (FIG. 16, 730, and FIG. 17, 740) around the hollow torus. The cavitation bubbles produced tend to collect the dispersed ions generated by the radiant energy from the nanofusion events. This provides a means of continuously producing large amounts cavitation bubbles which, along with bubbles of kinetically charged plasma are then forced to implode. A percentage of those cavitation and plasma bubbles then produce nanofusion events. Those nanofusion events then produce the large amounts of ionization referred to earlier.

As the water flows linearly around the hollow torus, the cations and ions impinge on the ring and rod electrodes (FIG. 18 and FIG. 19). The negative cations impinge on the ring electrode (800), producing an electrical charge on the ring electrode, which is carried to the outside of the torus by the ring supports (810) and mounts (880). At the same time, the lighter hydrogen/plasma ions impinge on the rod electrode (850) at the center of the torus section, producing a positive electrical charge on rod electrode, which is carried to the outside of the hollow torus by the rod support (860) and mount (885). The rod. Is at the section axis and is shaped to follow the section axis of the hollow torus. The volume of pure water between the ring and rod electrodes (145) acts to electrically insulate the ring and rod electrodes within the hollow torus. The electrical charges on the ring and rod electrodes are carried through to the outside of the torus by the electrode mounts (880, 885) then to the outside of the containment vessel to the master control system by high current insulated wiring. This is the source point for the electrical power produced by this system.

The two resonance frequencies within the water causes an acoustic resonance specifically at the center axis of the torus section (FIG. 17, 740). A lessor acoustic response also occurs at approximately three fourths of the diameter of the torus section. With the hydrogen/plasma bubbles collecting at the center axis (FIG. 1, 130 and FIG. 19, 130), the acoustic resonances (FIG. 16) will tend to cause additional cavitation bubbles which implode similar to the experiments that produced sonofusion and the sonoluminescence referenced before. Because this is continuous process, the cavitation/implosion events continue for most of the section axis (130) diameter of the hollow torus, except when the water flows past the ring and rod power output electrodes (FIG. 18 and FIG. 19), causing turbulence in the flow. The turbulence acts to allow the hydrogen and oxygen to recombine, which adds heat to the water in the hollow torus.

A small amount of deuterium is naturally occurring in the water on the Earth. Because of this a small amount, a small number of plasma and resonance cavitation bubbles will have a deuterium atom along with the hydrogen atom in those bubbles. An even smaller number of the plasma and resonance cavitation bubbles will have two deuterium nuclei in the bubble. The percentage of plasma bubbles with two deuterium nuclei can be increased by adding a small amount of heavy water to the pure water in the torus. The temperature needed to cause a fusion event of the two deuterium plasma/atoms is within the potential temperature of the imploding bubbles. This is enhanced by the system described in this application operating in a high pressure environment. Even though it is a very low percentage of imploding bubbles that cause nanofusion events, each event causes large amounts of radiant energy that then cause much higher levels of free ionization in the circulating water in the hollow torus. That higher level of ionization can then be harnessed to produce electrical power. The nanofusion events also cause heating of the water in the hollow torus. The ionization tends to absorb some of the initial energy, which is then released into the water when the ions are allowed to recombine adding to the heating of the water. Because the percentage of nanofusion events is relatively small, the nanofusion events tend to be spread around the hollow torus, preventing large scale fusion within the water containment, which would be catastrophic.

### Design and Implementation Considerations

One of the major factors limiting the output of this system is the ability to monitor the temperature in the system and properly cool the water in the hollow torus during system operation. Heat is a major by-product of primarily the nanofusion events, as well as a small amount from the recombination of the positive and negative ions. Tubing is coiled around the hollow torus containing a coolant that is pumped by a heat dissipation system outside of the containment vessel. That heat dissipation system must be sized such that the temperature inside the hollow torus is maintained at a safe level to prevent the formation of bubbles of water vapor, steam inside the hollow torus, which would disrupt the functioning of the processes inside the hollow torus. Some of that heat may be used to produce additional electrical power or for other savaging heat processes such as absorption HVAC systems.

The introduction of deuterium gas would exacerbate the danger of a catastrophic run-away fusion event by overly increasing the percentage fusion events along the very narrow section axis of the hollow torus. Even without a catastrophic event, too great a number of fusion events would overheat the water in a very small area, causing a spike in the containment vessel pressure. A sudden over pressure within the containment vessel might cause the containment vessel to burst, which would then become a steam explosion. A small amount of heavy water, D₂O, might be added to increase the power output of the system, but it would have to be carefully controlled.

While there may not be an upper limit to the physical size and power output of the system of this application, there is an inherent limitation in how small this system can be built and operated. The lower size limit is governed by how much the flowing water in the hollow torus can dissipate the heat generated by the nanofusion events as well as the level of ionization that can be generated by smaller amounts of water surrounding those events. Additionally there are considerations of shielding of the high energy radiation from those nanofusion events. The water in the hollow torus and containment vessel or larger units of this application provide that shielding through the amount of water in the larger units. At a certain point, the smaller units will not be able to provide that shielding without specific heavy metal shielding on the outside of the containment vessel. Also the smaller size units will tend to produce chemically reactive radiation products with additional need for safety considerations.

As noted previously, the volume of water between the outer cation zone and the inner plasma ion zone acts to electrically insulate the negative charges from the positive charges in the separated zones around the circumference of the system of this application. The dimension of that volume of pure water determines the workable voltage output of the system of this application. The larger the system, the higher the output voltage can be, the smaller the system the lower the output voltage can be.

Another factor in the design and implementation of units built from this application is the use of the traditional current based magneto hydro-dynamic drive. A major factor is the tendency to cause corrosion of the electrodes in the water of the hollow torus. This will create a contamination of the water which is often made up of metal oxides. These metal oxides can have a dampening effect on the operation of the hollow torus. Because the metal oxides tend to have higher densities that the water, the heaver materials will start to coat and cover the piezoelectric material coating the inside of the hollow torus, reducing the initiating ion production which reduces the amount of available ionic gases available for the acoustic cavitation necessary for the nanofusion activity. This accumulation of metal oxides in the water of the hollow torus will force the need for frequent maintenance and interior cleaning. The large amount of required downtime will greatly reduce the overall effectiveness of units using this method.

### BRIEF DESCRIPTION OF FIGURES

FIG. 1 Top View of the Hollow Torus Inside of the Containment Vessel
100 Hollow Torus
130 Torus Section Centerline through the Cavity of the Hollow Torus
150 Lighter Water Circulation Piping
160 Hollow Torus Water Level Maintenance Structure
165 Non-reactive Gas Removal and System Pure Water Level Maintenance Structure
170 Piping/Tubing for Circulation of System Coolant
180 Master Control System
185 Control and Power Cables Through the Wall of the Containment Vessel
190 Power Output Cable to Other Systems
200 Containment Vessel
250 Pure Water Filled Cavity of the Pressure Containment Vessel
260 System Pure Water Exchange Piping
280 High Pressure Relief Safety Valve
310 Electrode Mounts for Current Based Hydrodynamic Drive
330 Saddle Coils for Current Based Hydrodynamic Drive
390 Current Based Hydrodynamic Drive Acoustic Signal Pickup
500 Saddle Coils for the Electrostatic Based Hydrodynamic Acoustic Resonance Drive
510 High Voltage Electrodes for the Electrostatic Based Hydrodynamic Acoustic Resonance Drive
590 Electrostatic Based Hydrodynamic Drive Acoustic Signal Pickup
880 Mount Points and Electrical Contacts for Ring Electrode
885 Mount Point and Electrical Contact for Center Rod Electrode
935 Doppler Detection Acoustic Pickup

FIG. 2 Side View of the Hollow Torus inside the Containment Vessel through Section A-A
100 Hollow Torus
120 Piezoelectric Material Lining Inside of Hollow Torus
130 Torus Section Centerline through the Cavity of the Hollow Torus
145 Pure Water Filled Cavity of the Hollow Torus
150 Lighter Water Circulation Piping
155 Heavier Water Circulation Piping
160 Hollow Torus Water Level Maintenance Structure
165 Non-reactive Gas Removal and System Pure Water Level Maintenance Structure
180 Master Control System
185 Control and Power Cables Through the Wall of the Containment Vessel
200 Containment Vessel
260 System Pure Water Exchange Piping

FIG. 3 Section View of Hollow Torus at Current Based Drive Components through Section B-B
110 Shell of the Hollow Torus
145 Pure Water Filled Cavity of the Hollow Torus
300 Electrodes for Current Based Hydrodynamic Drive
310 Electrode Mounts for Current Based Hydrodynamic Drive
320 Mountings and Electrical Contacts for Current Based Hydrodynamic Drive
330 Saddle Coils for Current Based Hydrodynamic Drive

FIG. 4 Resonance Control Sub-System for Current Based Hydrodynamic Drive
200 Containment Vessel
300 Electrodes for Current Based Hydrodynamic Drive
330 Saddle Coils for Current Based Hydrodynamic Drive
340 Resonance Control Computer for Current Based Hydrodynamic Drive
345 Timing Signals for Half Wave and Quarter Wave Resonance Acoustics
350 Wave Form Generators for Half Wave and Quarter Wave Resonance Acoustics
354 Half Wave Resonance Acoustic Signal Patterns to Signal Amplifiers
356 Quarter Wave Resonance Acoustic Signal Patterns to Signal Amplifiers
360 High Amperage Acoustic Signal Amplifiers
364 Half Wave Acoustic, High Amperage Current to Hydrodynamic Drive Saddle Coils
366 Quarter Wave Acoustic, High Amperage Current to Hydrodynamic Drive Saddle Coils
370 Low Direct Current Power to Electrodes for Current Based Hydrodynamic Drive
390 Current Based Hydrodynamic Drive Acoustic Signal Pickup
910 Resonance Control System for Current Based Hydrodynamic Drive

FIG. 5 Single Regular Water Molecule Showing Dipole Electrostatic Field

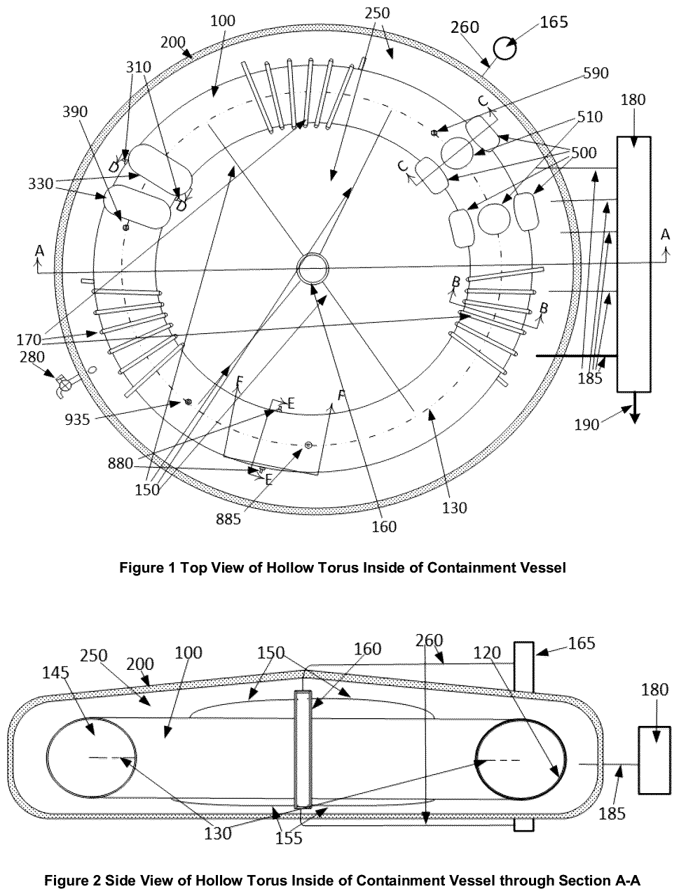

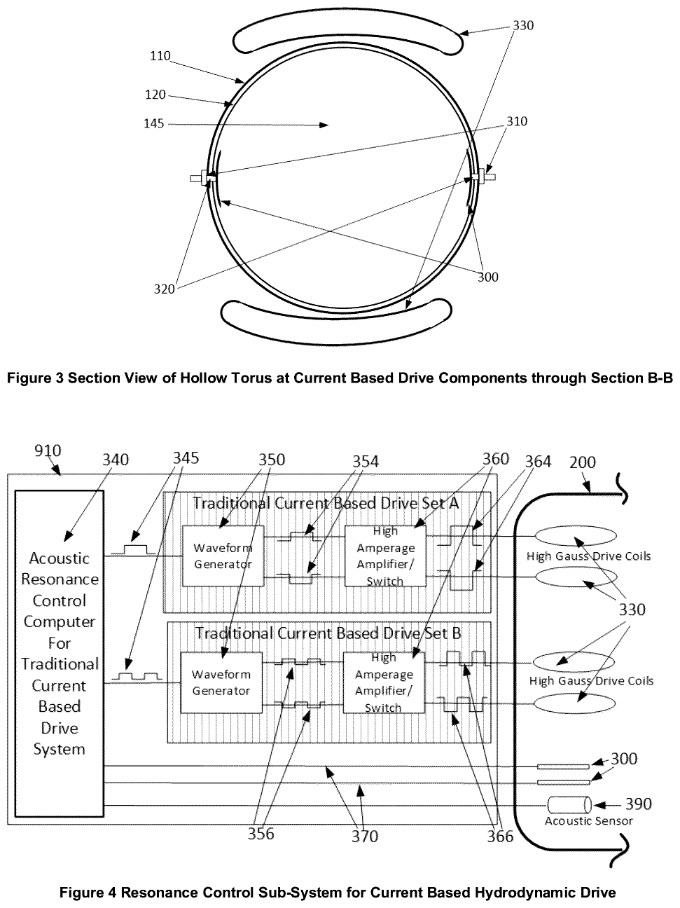

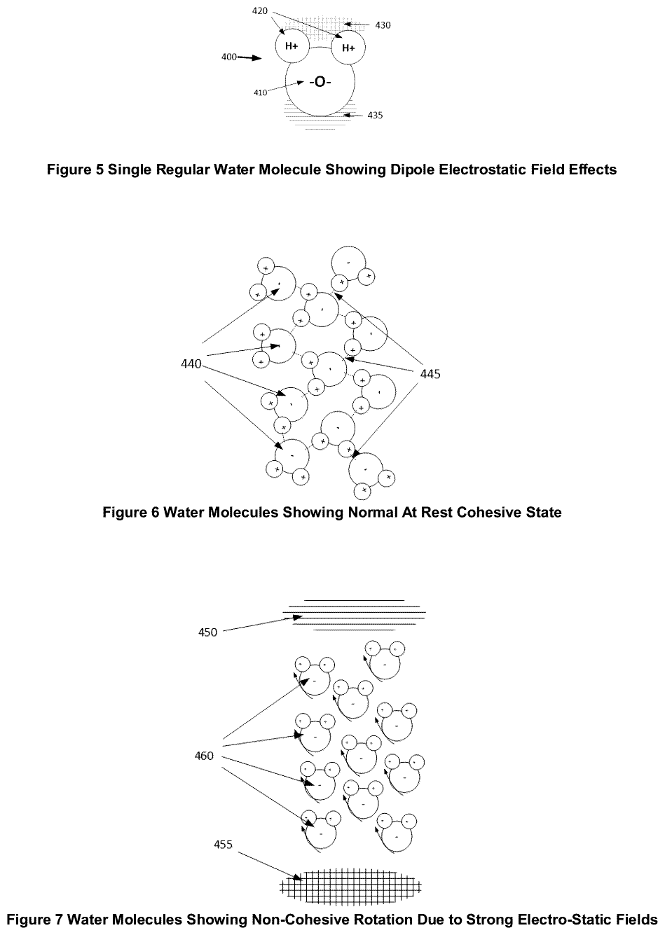

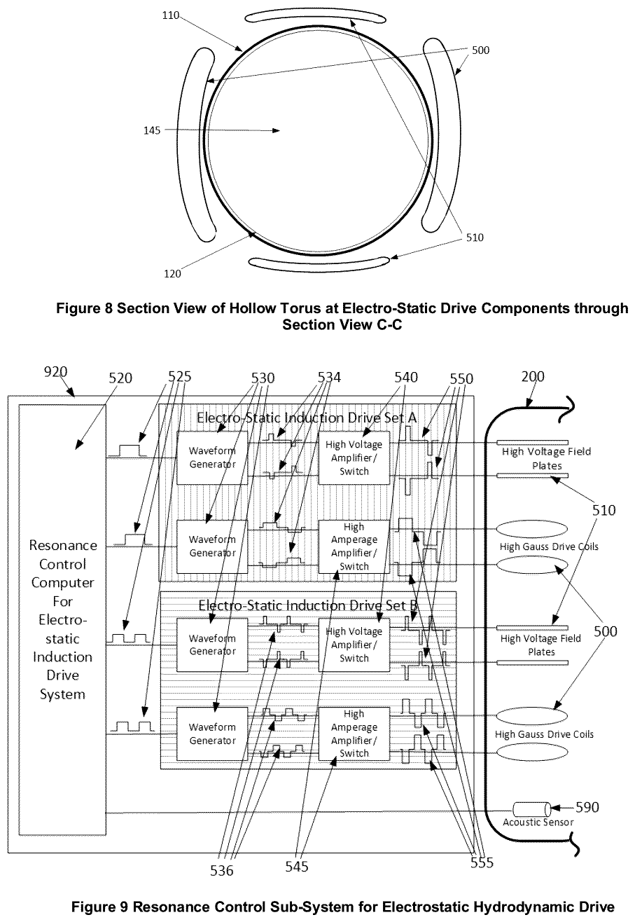

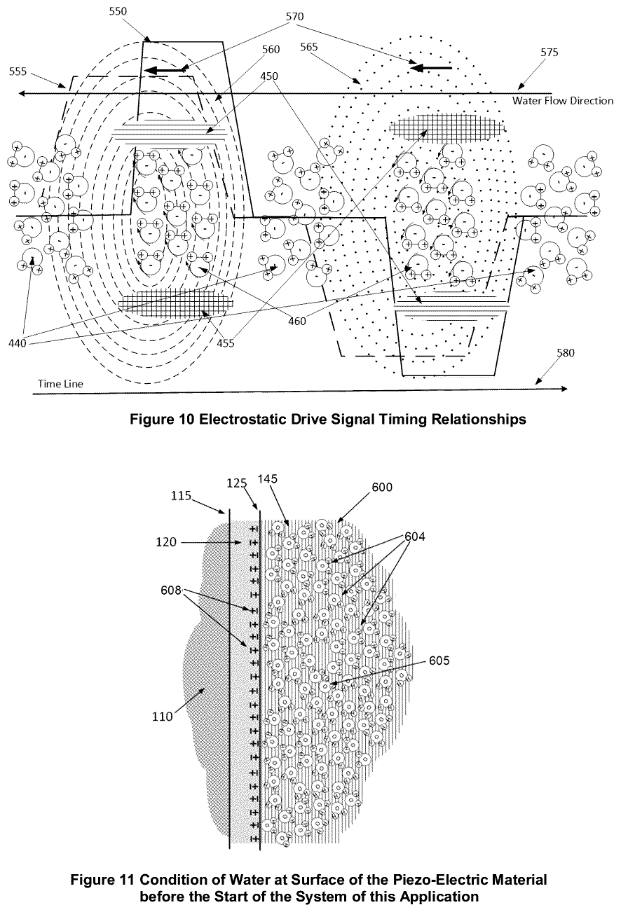

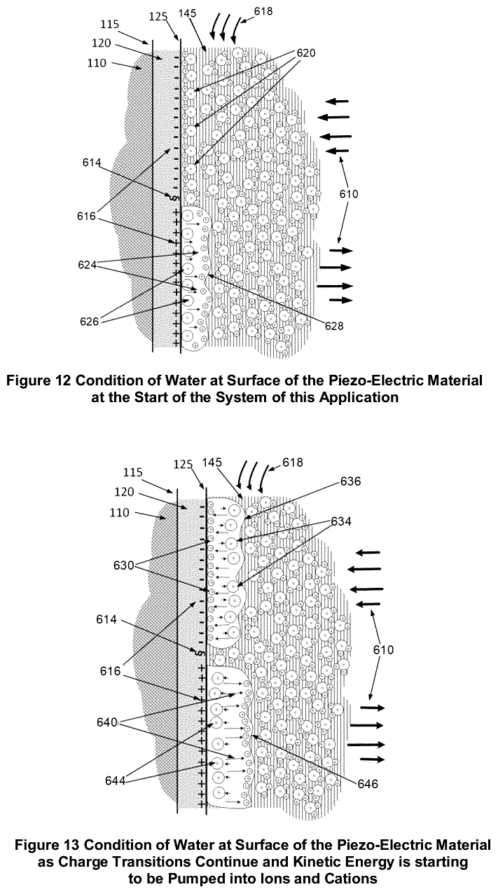

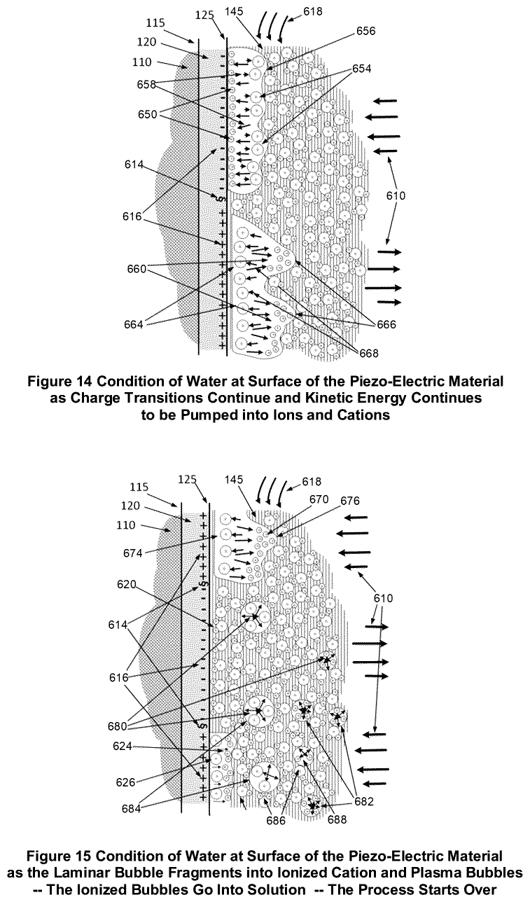

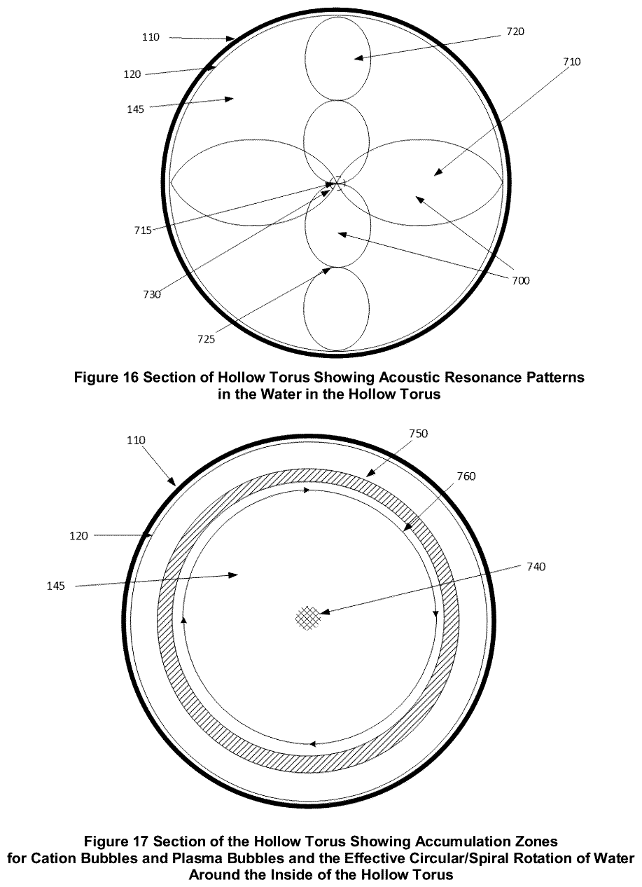

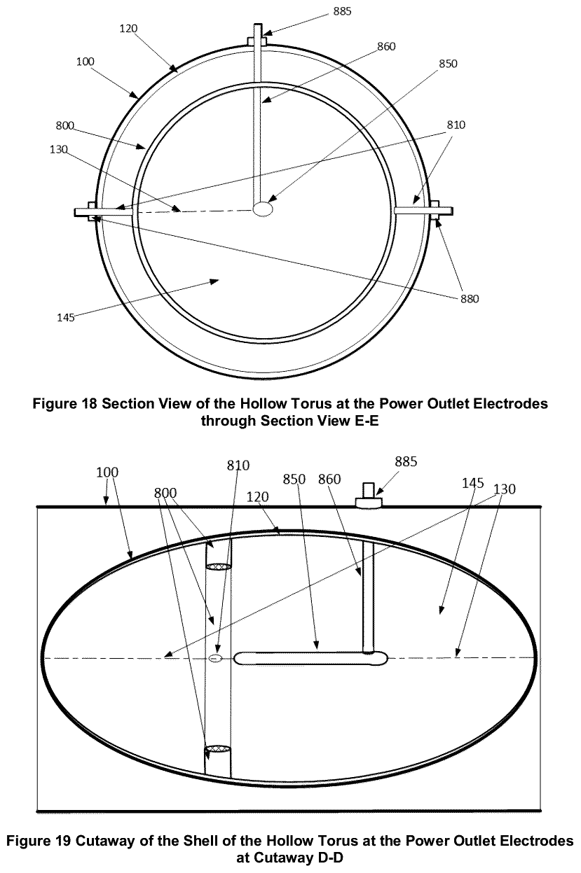

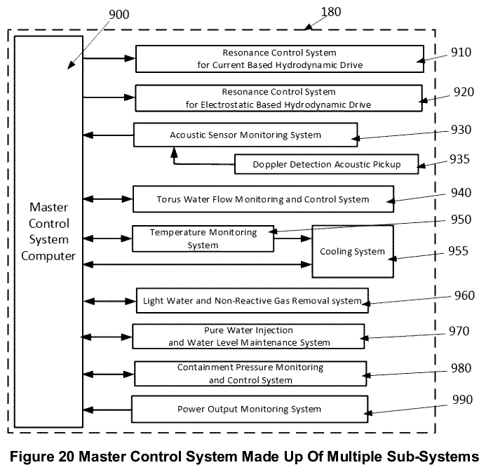

Effects
400 Regular Water Molecule
410 Oxygen Atom with Double Negative Effective Charge
420 Two Hydrogen Atoms with a Single Positive Effective Charge Each
430 Effective Positive Charge Pole Area
435 Effective Negative Charge Pole Area

FIG. 6 Water Molecules Showing Normal at Rest Cohesive State
440 Regular Water Molecules at Rest
445 Cohesive Bond between Regular Water Molecules at Rest

FIG. 7 Water Molecules Showing Non-Cohesive Rotation Due to Strong Electrostatic Fields
450 Strong Negative Electrostatic Field
455 Strong Positive Electrostatic Field
460 Regular Water Molecules Rotated without Cohesive Bonds due to Strong Electrostatic Fields

FIG. 8 Section View of Hollow Torus at Electro-Static Drive Components through Section View C-C
110 Shell of the Hollow Torus
145 Water Filled Cavity of the Hollow Torus
500 Saddle Coils for Electrostatic Based Hydrodynamic Acoustic Resonance Drive
510 High Voltage Electrodes for Electrostatic Based Hydrodynamic Acoustic Resonance Drive

FIG. 9 Resonance Control Sub-System for Electrostatic Hydrodynamic Drive
520 Resonance Control Computer for Electrostatic Based Hydrodynamic Drive
525 Timing Signals for Half Wave and Quarter Wave Resonance Acoustics
530 Wave Form Generators for Half Wave and Quarter Wave Resonance Acoustics
534 Half Wave Resonance Acoustic Signal Patterns to Signal Amplifiers
536 Quarter Wave Resonance Acoustic Signal Patterns to Signal Amplifiers
540 High Voltage Amplifier/Switches for Half Wave and Quarter Wave Resonance Drive Electrodes
545 High Current Amplifiers for Half Wave and Quarter Wave Resonance Drive Saddle coils
550 High Voltage Pulses to Electrostatic Hydrodynamic Resonance Drive Electrodes
555 High Amperage Pulses to Electrostatic Hydrodynamic Resonance Drive Saddle Coils
590 Acoustic Resonance Pulsating Drive Unit Acoustic Pickup

FIG. 10 Electrostatic Drive Signal Timing Relationships
440 Regular Water Molecules at Rest
450 Strong Negative Electrostatic Field
455 Strong Positive Electrostatic Field
460 Regular Water Molecules Rotated without Cohesive Bonds due to Strong Electrostatic Fields
560 High Gauss N-S Magnetic Field
565 High Gauss S-N Magnetic Field
570 Short Duration Flow Impulse to Water
575 Water Flow Direction
580 Timing/Time line Flow

FIG. 11 Condition of Water at Surface of the Piezo-Electric Material before the Start of the System of this Application
110 Shell of Hollow Torus
115 Inner Surface of Shell of Hollow Torus
120 Piezoelectric Material on Inner Surface of Hollow Torus
125 Inner Surface of Piezoelectric Material
145 Water in Cavity of Hollow Torus
600 Water Molecules at Rest before Start of the System of this Application
604 Regular Water Molecules with Random Cohesive Bonds
605 Occasional Heavy Water Molecule among Regular Water Molecules
608 Indeterminate State of Electrical Charge on Surface of Piezo Material

FIG. 12 Condition of Water at Surface of the Piezo-Electric Material at the Start of the System of this Application
110 Shell of Hollow Torus
115 Inner Surface of Shell of Hollow Torus
120 Piezoelectric Material on Inner Surface of Hollow Torus
125 Inner Surface of Piezoelectric Material
145 Water in Cavity of Hollow Torus
610 Resonant Acoustic Waves Cause Positive and Negative Pressure on Surface of Piezo-Electric Material
614 Pressures from Resonant Acoustic Waves Cause Electrical Charge Transients on Surface of Piezo-Electric Material
616 Area of Negative and Positive Transient Charges on Surface of Piezo-Electric Material
618 Water Flows in a Spiral Direction across the Surface of the Piezo-Electric Material
620 Transition Area of Negative Charge Attracts Hydrogen in Water Molecules
624 Transition Area of Positive Charge Strips Electrons and Repels Hydrogen Atoms, Become Ions
626 Transition Area of Positive Charge Attracts Oxygen Atoms Which Collect Freed Electrons, Become Cations
628 Separation of Hydrogen and Oxygen Atoms in Water Generates a Laminar Bubble on the Surface of the Piezo-Electric Material

FIG. 13 Condition of Water at Surface of the Piezo-Electric Material as Charge Transitions Continue and Kinetic Energy is starting to be pumped into Ions and Cations
110 Shell of Hollow Torus
115 Inner Surface of Shell of Hollow Torus
120 Piezoelectric Material on Inner Surface of Hollow Torus
125 Inner Surface of Piezoelectric Material
145 Water in Cavity of Hollow Torus
610 Resonant Acoustic Waves Cause Positive and Negative Pressure on Surface of Piezo-Electric Material
614 Pressures from Resonant Acoustic Waves Cause Electrical Charge Transients on Surface of Piezo-Electric Material
616 Area of Negative and Positive Transient Charges on Surface of Piezo-Electric Material
618 Water Flows in a Spiral Direction across the Surface of the Piezo-Electric Material
630 Next Negative Charge Transition Attracts Free Hydrogen Ions
634 Next Negative Charge Transition Repels Free Oxygen Cations
636 Laminar Bubble Expands as Next Negative Transition Fully Separates Hydrogen Ions and Oxygen Cations
640 Next Positive Charge Transition Repels Free Hydrogen Ions Forcing Greater Separation
644 Next Positive Charge Transition Attracts Free Oxygen Cations Forcing Greater Separation
646 Laminar Bubble Size Increases as Ions and Cations Have Greater Separation

FIG. 14 Condition of Water at Surface of the Piezo-Electric Material as Charge Transitions Continue and Kinetic Energy Continues to be pumped into Ions and Cations
110 Shell of Hollow Torus
115 Inner Surface of Shell of Hollow Torus
120 Piezoelectric Material on Inner Surface of Hollow Torus
125 Inner Surface of Piezoelectric Material
145 Water in Cavity of Hollow Torus
610 Resonant Acoustic Waves Cause Positive and Negative Pressure on Surface of Piezo-Electric Material
614 Pressures from Resonant Acoustic Waves Cause Electrical Charge Transients on Surface of Piezo-Electric Material
616 Area of Negative and Positive Transient Charges on Surface of Piezo-Electric Material
618 Water Flows in a Spiral Direction across the Surface of the Piezo-Electric Material
650 Next Negative Charge Transition Attracts Hydrogen Ions, Adding Kinetic Energy
654 Next Negative Charge Repels Oxygen Cations, Adding Kinetic Energy
656 Laminar Bubble Size Decreases Slightly As Hydrogen Ions Are Pulled Back From Bubble Surface
658 Charge Transitions Pump Additional Kinetic Energy into Ions and Cations
660 Next Positive Charge Transition Repels Lighter Hydrogen Ions, Adding More Kinetic Energy
664 Next Positive Charge Transition Attracts Heaver Oxygen Cations, Adding More Kinetic Energy
666 Laminar Bubble Increases Size and Deform as Ions and Cations Continue to Separate and Begins to Delaminate from Surface of Piezo Material
668 Charge Transitions Continue to Pump Additional Kinetic Energy into Ions and Cations

FIG. 15 Condition of Water at Surface of the Piezo-Electric Material as the Laminar Bubble Fragments into Ionized Cation and Plasma Bubbles; the Ionized Bubbles Go Into Solution and the Process Starts Over
110 Shell of Hollow Torus
115 Inner Surface of Shell of Hollow Torus
120 Piezoelectric Material on Inner Surface of Hollow Torus
125 Inner Surface of Piezoelectric Material
145 Water in Cavity of Hollow Torus
610 Resonant Acoustic Waves Cause Positive and Negative Pressure on Surface of Piezo-Electric Material
614 Pressures from Resonant Acoustic Waves Cause Electrical Charge Transients on Surface of Piezo-Electric Material
616 Area of Negative and Positive Transient Charges on Surface of Piezo-Electric Material
618 Water Flows in a Spiral Direction across the Surface of the Piezo-Electric Material
670 Next Positive Charge Transition Repels the Hydrogen Ions Farther With Greater Kinetic Energy
674 Next Positive Charge Transition Only Slightly Attracts the Oxygen Cations
676 The Laminar Bubble Separates from the Surface of the Piezo Material
678 Additional Kinetic Energy is Pumped into Ions and Cations
680 The Kinetic Energy of the Ions and Cations Generate Sustainable Bubbles from Laminar Bubble
682 The Ions Form Plasma Bubbles as Laminar Bubble Breaks Up
684 The Cations Form Negative Ionized Bubbles as Laminar Bubble Breaks Up
686 The Plasma and Cation Bubbles go into Solution in Pure Water of the Hollow Torus
688 A Few of the Plasma Bubbles Contain 2 Deuterium Ions, the Seed of the Nanofusion Events

FIG. 16 Section of Hollow Torus Showing Acoustic Resonance Patterns in the Water in the Hollow Torus
110 Shell of Hollow Torus
120 Piezoelectric Material on Inner Surface of Hollow Torus
145 Water in Cavity of Hollow Torus
700 Acoustic Resonance Patterns in the Hollow Torus Section
710 Half Wave Acoustic Resonance Pattern
715 Half Wave Acoustic Resonance Pressure Zone
720 Quarter Wave Acoustic Resonance Pattern
725 Quarter Wave Acoustic Resonance Pressure Zone
730 Point of Convergence between Half and Quarter Wave Patterns at Section Axis

FIG. 17 Section of the Hollow Torus Showing Accumulation Zones for Cation Bubbles and Plasma Bubbles and the Effective Circular/Spiral Rotation of the Water around the Inside of the Hollow Torus
110 Shell of Hollow Torus
120 Piezoelectric Material on Inner Surface of Hollow Torus
145 Water in Cavity of Hollow Torus
740 Zone of Lighter Weight Ion Accumulation Close to Hollow Torus Section
750 Zone of Heavier Weight Cation Accumulation Toward Outside of Hollow Torus Section
760 Circular/Spiral Flow of Water around the Inside of the Hollow Torus Section

FIG. 18 Section View of the Hollow Torus at the Power Outlet Electrodes-Section View E-E
110 Shell of Hollow Torus
120 Piezoelectric Material on Inner Surface of Hollow Torus
130 Torus Section Centerline through the Cavity of Hollow Torus
145 Water in Cavity of Hollow Torus
800 Ring Electrode
810 Ring Electrode Support and Electrical Connection
850 Rod Electrode
860 Rod Electrode Support and Electrical Connection
880 Mount Points and Electrical Contacts for Ring Electrode
885 Mount Point and Electrical Contact for Center Rod Electrode

FIG. 19 Cutaway of the Shell of the Hollow Torus at the Power Outlet Electrodes at Cutaway D-D
110 Shell of Hollow Torus
120 Piezoelectric Material on Inner Surface of Hollow Torus
130 Torus Section Centerline through the Cavity of Hollow Torus
145 Water in Cavity of Hollow Torus
800 Ring Electrode
810 Ring Electrode Support and Electrical Connection
850 Rod Electrode
860 Rod Electrode Support and Electrical Connection
880 Mount Points and Electrical Contacts for Ring Electrode
885 Mount Point and Electrical Contact for Center Rod Electrode

FIG. 20 Master Control System Made Up Of Multiple Sub-Systems
180 Master Control System
900 Master Control System Computer
910 Resonance Control System for Current Based Hydrodynamic Drive
920 Resonance Control System for Electrostatic Based Hydrodynamic Drive
930 Acoustic Resonance Sensor and Monitoring System
935 Doppler Detection Acoustic Pickup
940 Torus Water Flow Monitoring and Control System
950 Temperature Monitoring System and Cooling System Control
955 Cooling System
960 Light Water and Non-Reactive Gas Removal System
970 Water Injection and Water Level Maintenance System
980 Containment Pressure Monitoring and Control System
990 Power Output Control System

What is claimed:

1. A system and methods for the production of electrical power by means of nucleosynthesis in a flowing fluid of water in a closed system with one or more sets of acoustically resonance tuned pulsating magneto hydrodynamic drives providing the moving force for the flowing fluid water comprising;
a) A hollow torus made of hard, non-magnetic, electrically non-conductive, corrosion resistant, moderately high temperature resistant material. formed by rotating a closed section diameter circle in three dimensional space about an axis that is coplanar with the circle with the axis of rotation not intersecting the circle, forming a hollow ring-shaped geometry with a circular cross section;
b) With piezoelectric material with a very smooth inner surface lining the inner surface of the hollow torus;
c) With the hollow torus filled with water made up of pure regular water (H²O) and a small amount of heavy water (D²O);
d) With a water level structure at the center axis of the hollow torus for the purpose of maintaining full capacity of water in the hollow torus that also provides for the removal of water containing dissolved gasses that has accumulated the top of the hollow torus;
e) With one or more pulsating electrostatic induction hydrodynamic drive unit pairs attached to the outer surface of the hollow torus consisting of two drive units in close proximity where one of the drive units is pulsing at a frequency that is at one half the acoustic resonant wavelength of the water in the section cavity of the hollow torus and the other drive unit is pulsing at one quarter the resonant acoustic wavelength of the water in the section cavity of the hollow torus, causing acoustic resonance pulses to propagate through the water in the hollow torus;
f) With one or more pulsating traditional current based magneto-hydrodynamic drive units consisting of two drive units in close proximity where there is a low amperage current between the current electrodes of both drive units and where saddle coils of one unit s is pulsing at one half the acoustic wavelength of the water in the section cavity of the hollow torus and the saddle coils of the other unit is pulsing at one quarter acoustic resonant wavelength of the water in the section cavity of the hollow torus causing acoustic resonance pulses to propagate through the water in the hollow torus;
g) With an acoustic sensor for each pair of magneto hydrodynamic drive units to monitor the resonant frequencies in the water produced by each magneto hydrodynamic drive pair;
h) With one or more acoustic sensors attached to hollow torus at some distance from the pulsating magneto hydrodynamic drive pairs to monitor the propagation of the resonant pulses in the water from the drive pairs and any Doppler effect on the frequency of the pulses due to the speed of the water moving past the sensor;
i) With the water in the hollow torus being acted on by the magneto hydrodynamic drive units causing the water to flow in a specific direction around the inside of the circular hollow torus, which causes the water flowing inside the hollow torus to take on a spiral flow pattern as it moves around in the circular form of the hollow torus with the circular cross section due to natural forces within the flowing water, causing a circular flow pattern around the section axis of the hollow tours;
j) With the acoustic resonance pulses propagating through the water in the hollow torus producing zones of alternating pressures on the surface of the piezoelectric material and a zone of alternating pressure, cavitation, and bubble implosion along the section axis of the hollow torus;
k) With the acoustic resonant pulses propagating through the water acting on the piezoelectric material lining the inner surface of the hollow torus, causing transient positive and negative electrical charges to form on the surface of the piezoelectric material, which in turn causes the molecules of water to separate into component atomic elements that make up the water causing bubbles of positive charged ion and negatively charged cations on the surface of the piezoelectric material;
l) With the continuing transitioning of the transient electrical charges on the surface of the piezoelectric material acting pump kinetic energy into the component elements producing statically charged bubbles of kinetically charged cations (O⁻) and statically charged bubbles of kinetically charged plasma, primarily Hydrogen plasma (H⁺) with a small amount of Deuterium plasma (D⁺) from the small amount of heavy water in the water in the hollow torus;
m) With small amount of heavy water in the water in the hollow torus, a small number of the statically charged bubbles of kinetically charged plasma bubbles will contain two Deuterium plasma ions (D⁺) from heavy water molecules;
n) With the statically charged bubbles of kinetically charged cations and plasma coming into solution in the water, making the water an ionic solution of water;
o) With the circular flow pattern around the section axis of the hollow torus causing the lighter statically charged plasma bubbles to concentrate along the section axis of the hollow torus while the heavier statically charged cation bubbles concentrate closer to the inner surface of the hollow torus;
p) With the lighter bubbles of kinetically charged plasma concentrated along the section axis of the hollow torus in the zone of alternating pressure, cavitation and implosion, the bubbles of plasma are caused to implode with momentary very high temperatures within the plasma bubbles;
q) With the small number of the plasma bubbles that contain plasma ions from heavy water (D+) and the very high temperature of the imploding plasma bubbles, an individual fusion event will be caused to occur, sporadically, continuously along the section axis of the hollow torus, generating ionizing radiation with each individual fusion event, causing the development ionization products of free positive charged ions and negatively charged cations;
r) With the ionized water solution able to retain the products of ionizing radiation, the circular motion of the water around the section axis of the hollow torus tends to cause the ionization products to collect in specific zones, the heaver cations toward the outer portion of the section axis while the lighter ions tend to collect close to the center section axis around the circumference of the hollow torus;
s) With one or more power extraction electrode sets enclosed in the hollow torus consisting of a ring electrode with a diameter of seven eights of the diameter of the section of the hollow torus and a rod electrode in line with the section axis of the hollow torus where the rod electrode is positioned in the center of the ring electrode, with supports for each ring electrode going through to the outside surface of the hollow torus that also acts as electrical connection to each ring electrode and a support for each rod electrode that goes through to the outside of the surface of the hollow torus that also acts electrical connection to each rod electrode;
t) With the hollow torus, the attached magneto hydrodynamic drive units, and the enclosed power extraction electrode sets all enclosed in a pressure containment vessel made of non-magnetic, corrosion resistant, high temperature resistant material, filled with water, pressurized up to 300 psig;
u) With one or more coils of tubing made of corrosion resistant material wrapped around the outer surface of the hollow torus with coolant running through the tubing where the tubing is connected to an input and output manifold which in turn is connected to piping that extends to the outside of the containment vessel by means of high pressure seals to a structure that acts as a cooling system for the heat generated by the processes generated within the operating hollow torus;
v) With piping that extends outside the containment vessel by means of high pressure seals between the water level structure at the center axis of the torus and a structure outside of the torus that functions allow the separation the water in the hollow torus of any accumulation of reactive and non-reactive gasses that are collected by the water level structure at the center axis of the hollow torus and to pump water back into the water level structure at the center axis of the hollow torus;
w) With wiring and cabling from each hydro-magneto drive pairs and acoustic sensors to a resonance control system outside the containment vessel though high pressure bulkhead seals or high pressure bulkhead multi-conductor connectors, and wiring from the ring and rod electrodes to a voltage and current control system outside the containment vessel through high pressure bulkhead seals or high pressure bulkhead connectors, and temperature sensors attached to the hollow torus with wiring to a cooling system controller outside of the containment vessel through high pressure bulkhead seals or high pressure bulkhead connectors;
x) With a master control system outside of the containment vessel that monitors and controls all of the functions and processes of the operation of the hollow torus consisting of a master control computer, and resonance control systems for the magneto hydrodynamic drive units, and an acoustic resonance monitoring system, and water flow monitoring system, and a temperature monitoring and cooling system control system, and light water and non-reactive gas removal control system, and a water injection and water level maintenance control system, and a containment pressure monitoring and control system, and a power output monitoring and control system.

2. A method of producing a flowing ionic solution of pure water by means of statically charged bubbles of kinetically charged cations and plasma from the pure water by means of acoustic waves acting on piezoelectric material on the inner surface of an enclosed vessel, filled initially with pure water and an acoustic generation device that can produce resonant or standing waves in the enclosed vessel without the need for high heat herein known as Piezo Pumped Plasma, comprising;
a. One or more acoustic generation devices produce acoustic waves in the flowing pure water at resonant frequencies the native full wave resonance of the containment vessel based on the speed of sound through the pure water;
b. The acoustic frequencies should be at a doubling harmonic of the base frequency, for example a base frequency of twice the resonant full wave frequency, then twice the base frequency, then four times the base frequency and so on;
c. the acoustic resonant pulses propagating through the pure water acting on the piezoelectric material lining the inner surface of the containment vessel, causing transient positive and negative electrical charges to form on the surface of the piezoelectric material, which in turn causes the molecules of water on the surface of the piezoelectric material to separate into component atomic elements that make up the water, causing bubbles of positive charged ion and negatively charged cations on the surface of the piezoelectric material;
d. As the acoustic resonant pulses continue to propagate through the pure water the transient electrical charges on the surface of the piezoelectric material continue to transition which acts to further separate the cations from the ions while continuing to pump kinetic energy into the component elements;
e. As the kinetic energy of the separated cations and ions continues to increase, causing the cations and ions to transition into a gas state, with the ions now becoming plasma gas;
f. The cation and plasma bubbles on the surface of the piezoelectric material start to isolate and separate into discrete statically charged bubbles of negatively charged cations (O⁻², OH⁻) and positively charged plasma;
g. Because the kinetic energy of the cations and plasma continues to maintain the inner gas pressure of the bubbles of cations and plasma, the statically charged bubbles go into solution in pure water, forming an ionic solution of pure water made from pure water.

3. In claim 2 wherein the ionic solution of pure water can be used to retain the radiant energy products from radioactive material and suppress the recombination of the Hydrogen and Oxygen/Hydroxide ions and make those ions available for electrostatic charge collection to provide for electrical energy potential to produce voltage and current and make use that electrical energy produced from that radioactive material.

4. In claim 2 wherein the ionic solution of pure water can be used to retain the radiant energy products from nucleosynthesis (fusion) events and suppress the recombination of the Hydrogen and Oxygen/Hydroxide ions and make those ions available for electrostatic charge collection to provide for electrical energy potential to produce voltage and current and make use that electrical energy produced from those nucleosynthesis (fusion) events.

5. In claim 2 wherein the bubbles of plasma in solution in the pure water become candidates for forced implosion from acoustic forces based on the specific design of the systems that utilize acoustic forces to continue to act on the bubbles of kinetically charged plasma, where the acoustic forces exceed the internal gas pressure and the bubbles of kinetically charged plasma are forced to implode for the purpose causing nucleosynthesis (fusion) events to occur.

6. A method producing movement of water in an enclosed system by means of electrostatic induction magneto hydrodynamic drive units with each electrostatic induction magneto hydrodynamic drive unit consisting of;
a) An enclosing channel containing water, that can be circular or square or rectangular;
b) Two high voltage electrode plates, outside of and close to the outer surface of the enclosing channel, positioned on opposite sides of the enclosing channel such that when energized the electrode plates produce an electrostatic charge field between the electrode plates, said electrostatic field being strong enough to force the water molecules to rotate and align the hydrogen dipole of the water molecules with the electrostatic field produced by the energized electrode plates as the electrode plates become energized;
c) Two saddle coils on the outer surface enclosing channel, positioned on opposite sides of the enclosing channel normal to the alignment of the electrode plates such that when the saddle coils are energized they produce a magnetic field between them that encompasses the electrostatic field produced by the energized electrode plates at a ninety degree angle to the direction of the electrostatic field produced by the electrode plates;
d) With the electrical signals to the saddle coils and the high voltage plates together being alternating current;
e) With electrical signals to the saddle coils and high voltage plates correctly timed such that the leading edge of the high voltage signal to the high voltage electrode plates occur after the magnetic field produced by the current to the coils is at maximum strength;
f) With the direction and alignment of the magnetic field and the electrostatic field causing rotation of hydrogen dipole of the water molecules causing an impulse of force of motion in the water molecules consistent with Flemings Left Hand Rule;
g) With the electrical signals to the high voltage plates and the saddle coils being continuous and the impulses of force of motion being continuous such that the force of motion builds up and causes the water into full motion.

7. In claim 6 wherein the current to the saddle coils is constant direct current and the signals to the high voltage electrode plates is pulsing direct current.

8. In claim 6 wherein the saddle coils are replaced with strong permanent magnets and the signals to the high voltage electrode plates is pulsing direct current.

9. In claim 6 wherein the enclosing channel is part of a closed recirculating system.

10. In claim 6 wherein the enclosing channel is part of an open linier non-recirculating system.
